(19) United States
(12) Patent Application Publication
(10) Pub. No.: US 2010/0318939 A1
(43) Pub. Date: Dec. 16, 2010

(54) METHOD FOR PROVIDING LIST OF CONTENTS AND MULTIMEDIA APPARATUS APPLYING THE SAME

(75) Inventor: Ji-bum MOON, Seoul (KR)

Correspondence Address: Cha & Reiter, LLC, 17 Arcadian Avenue, Suite 208, Paramus, NJ, 07652, US

(73) Assignee: SAMSUNG ELECTRONICS CO., LTD., Gyeonggi-Do (KR)

(21) Appl. No.: 12/782,788

(22) Filed: May 19, 2010

(30) Foreign Application Priority Data
Jun. 10, 2009 (KR) 2009-0051439

(51) Int. Cl. G06F 3/048

(52) U.S. Cl. 715/830; 715/810

(57) ABSTRACT

A method for providing a list of contents and a multimedia apparatus applying the same are provided. At least one of a set of attributes relating to current content that is being played is set as a reference attribute, and a list of contents which are associated with the current content in terms of an attribute value of the reference attribute is displayed on a content play screen. Accordingly, a user is able to utilize a list of desired contents more easily and simply than known heretofore.

### CLAIM OF PRIORITY

This application claims priority from Korean Patent Application No. 10-2009-51439, filed on Jun. 10, 2009, in the Korean Intellectual Property Office, the disclosure of which is incorporated herein by reference in its entirety.

### BACKGROUND OF THE INVENTION

1. Field of the Invention

The present invention relates to a method for providing a list of contents and a multimedia apparatus applying the same. More particularly, the present invention relates to a method for providing a list of contents regarding current content which is being accessed, and a multimedia apparatus applying the same.

2. Description of the Related Art

Thanks to the development of a high capacity digital storage apparatus and the ongoing advancement of compression technology, the amount of contents that can be stored in a particular digital storage apparatus has greatly increased over a relatively short period of time. However, as the amount of contents that can be stored in a digital storage apparatus increases, there is a problem in terms of increased delay as a user confronts increased difficulty in searching for and retrieving a desired content for play by a player. This problem becomes more serious if the digital storage apparatus has a small space to display data like a portable MP3 player or a portable multimedia player (PMP).

For example, in order to retrieve and play music content using an MP3 player, a user has to go through a complicated procedure, such as selecting a main menu, selecting a music item, selecting an album title and then selecting one of songs included in the album. Therefore, the user in inconvenienced by following such a complicated procedure and having to select a list in order to access music content, or any other type of contents.

Typically, the user wishes to easily use a list of contents as he/she desires. Therefore, there is a need for a method for providing a list of contents desired by a user more easily and simply than known heretofore.

### SUMMARY OF THE INVENTION

The present invention may overcome the above disadvantages and provide advantages by providing a method for providing a list of contents, in which any one of a plurality of attributes relating to current content which is being played is set as a reference attribute, and a list of contents which correspond to the current content in terms of an attribute value of the reference attribute is displayed on a content play screen, and a multimedia apparatus for applying the same.

According to an exemplary aspect of the present invention, a method for providing a list of contents preferably includes: while playing specific content, setting any one of a plurality of attributes relating to the specific content which is being played as a reference attribute, and displaying a list of contents on a content play screen which correspond to the specific content in terms of an attribute value of the reference attribute.

According to an exemplary aspect of the present invention, the displaying operation may display a list of contents which have the same attribute value as that of the specific content on the content play screen.

According to an exemplary aspect of the present invention, the displaying operation may display the list of contents on the content play screen while the specific content is being played.

According to an exemplary aspect of the present invention, the reference attribute may be at least one of metadata items of the specific content and a pre-set list.

According to an exemplary aspect of the present invention, the specific content may be music content, and the reference attribute may be at least one of an album, an artist, a genre, a rank, a year, and a playlist.

According to an exemplary aspect of the present invention, the specific content comprise, for example, picture content, and the reference attribute may comprise at least one of a color, a size, an F-number, a focal distance (f), a year, a camera model, and GPS information.

According to an exemplary aspect of the present invention, if the reference attribute is changed by a user, the displaying operation may display a list of contents which correspond to the specific content in terms of an attribute value of the changed reference attribute on the content play screen.

The method may further include displaying an icon to receive a command to change the reference attribute, and, if the icon is manipulated by the user, then the displaying operation may display a list of contents which correspond to the specific content in terms of an attribute value of the changed reference attribute on the content play screen.

According to an exemplary aspect of the present invention, there may be a pre-set number of reference attributes and the reference attribute may be changed in a pre-set order. The method may further include changing the reference attributes in sequence according to the pre-set number and the pre-set order if the icon is manipulated.

According to another exemplary aspect of the present invention, a multimedia apparatus includes: a display unit which displays a video and a guide user interface (GUI), and a controller which controls playing specific content, setting any one of attributes relating to the specific content which is being played as a reference attribute, and displaying a list of contents which correspond to the specific content in terms of an attribute value of the reference attribute on a content play screen.

According to an exemplary aspect of the present invention, the controller may control, for example, displaying a list of contents which have the same attribute value as that of the specific content on the content play screen.

According to an exemplary aspect of the present invention, the controller may also control displaying the list of contents on the content play screen while the specific content is being played.

According to an exemplary aspect of the present invention, the reference attribute may be, for example, at least one of metadata items of the specific content and a pre-set list.

According to an exemplary aspect of the present invention, the specific content may be, for example, music content, and the reference attribute may be at least one of an album, an artist, a genre, a rank, a year, and a playlist.

According to an exemplary aspect of the present invention, the specific content may be, for example, picture content, and the reference attribute may be at least one of a color, a size, an F-number, a focal distance (f), a year, a camera model, and GPS information.

According to an exemplary aspect of the present invention, if the reference attribute is changed by a user, the controller may control displaying a list of contents which correspond to the specific content in terms of an attribute value of the changed reference attribute on the content play screen.

According to an exemplary aspect of the present invention, the controller may also control displaying an icon to receive a command to change the reference attribute, and, if the icon is manipulated by the user, the controller may control displaying a list of contents which correspond to the specific content in terms of an attribute value of the changed reference attribute on the content play screen.

According to an exemplary aspect of the present invention, there may be a pre-set number of reference attributes and the reference attribute may be changed in a pre-set order, and the controller may change the reference attribute in sequence according to the pre-set number and the pre-set order if the icon is manipulated.

Additional exemplary aspects and advantages of the present invention will be set forth in the detailed description, will be obvious from the detailed description, or may be learned by practicing the invention.

### BRIEF DESCRIPTION OF THE DRAWINGS

The above and/or other aspects of the present invention will be more apparent by describing in detail exemplary embodiments thereof, with reference to the accompanying drawings in which:

FIG. 1 is a view illustrating a music play screen according to an exemplary embodiment of the present invention;

FIG. 2A is a view illustrating a music play screen which displays a list of contents regarding all music while a song is being played according to an exemplary embodiment of the present invention;

FIG. 2B is a view illustrating a music play screen which displays a list of contents if a reference attribute is ‘Album’ and a reference attribute value is ‘Not Much Going On’ according to an exemplary embodiment of the present invention;

FIG. 3A is a view illustrating a music play screen which displays a list of contents regarding all music while a song is being played according to an exemplary embodiment of the present invention;

FIG. 3B is a view illustrating a music play screen which displays a list of contents if a reference attribute is ‘Album’ and a reference attribute value is ‘Album 1’ according to an exemplary embodiment of the present invention;

FIG. 3C is a view illustrating a music play screen which displays a list of contents if a reference attribute is ‘Artist’ and a reference attribute value is ‘Artist 1’ according to an exemplary embodiment of the present invention;

FIG. 3D is a view illustrating a music play screen which displays a list of contents if a reference attribute is ‘Playlist’ and a reference attribute value is ‘Playlist 1’ according to an exemplary embodiment of the present invention;

FIG. 4A is a view illustrating a picture display screen which displays a list of contents regarding all pictures while a picture is being displayed according to another exemplary embodiment of the present invention;

FIG. 4B is a view illustrating a picture display screen which displays a list of contents if a reference attribute is ‘Color’ according to another exemplary embodiment of the present invention;

FIG. 5A is a view illustrating a picture display screen which display a list of contents regarding all pictures in the form of a thumbnail according to still another exemplary embodiment of the present invention;

FIG. 5B is a view illustrating a picture display screen which displays a list of contents in the form of a thumbnail if a reference attribute is ‘Color’ according to still another exemplary embodiment of the present invention;

FIG. 6 is a flowchart illustrating a method for displaying a list of contents according to an exemplary embodiment of the present invention; and

FIG. 7 is a block diagram illustrating a multimedia apparatus according to an exemplary embodiment of the present invention.

### DETAILED DESCRIPTION

Hereinafter, the present invention will be described in greater detail with reference to the accompanying drawings, in which exemplary embodiments are shown.

In the following description, same reference numerals are used for the same elements when they are depicted in different drawings. The matters defined in the description, such as detailed construction and elements, are provided to assist a person of ordinary skill in the art with a comprehensive understanding of the invention. Thus, it is apparent that the exemplary embodiments of the present invention can be carried out without those specifically defined matters. Also, functions or elements known in the related art may not be described in detail when they might obscure appreciation of the present invention by a person of ordinary skill in the art with unnecessary detail about known elements or functions.

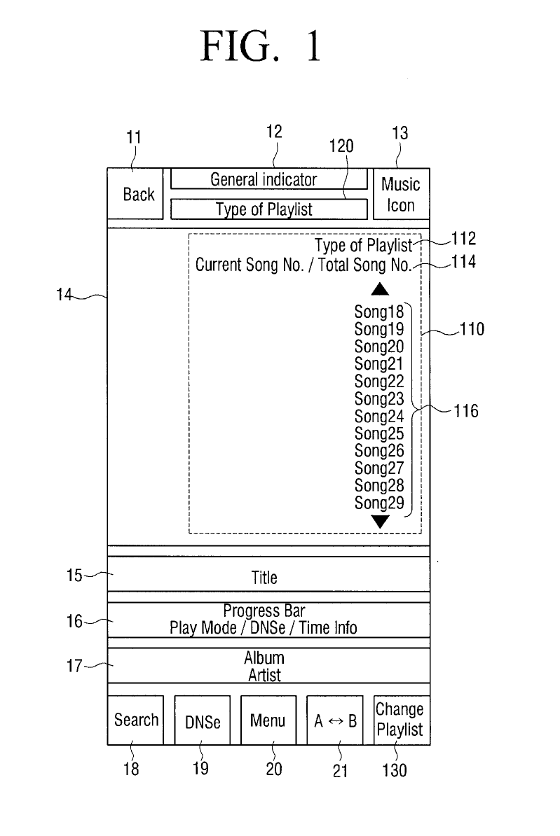

FIG. 1 is a view illustrating a music play screen of a multimedia apparatus according to an exemplary embodiment of the present invention. As shown in FIG. 1, the music play screen preferably includes a ‘Back’ area 11, a ‘General Indicator’ area 12, a ‘Music Icon’ area 13, a picture display area 14, a ‘Title’ area 15, a ‘Progress Bar’ area 16, an ‘Album/Artist’ area 17, a ‘Search’ button 18, a ‘digital natural sound engine (DNSe)’ button 19, a ‘Menu’ button 20, a section repeat button 21, a contents list display area 110, a reference attribute display area 120, and a reference attribute change icon 130. A person of ordinary skill in the art understands and appreciates that the term “button” is to be interpreted broadly.

The ‘Back’ area 11 displays a back button. The ‘General Indicator’ area 12 displays information regarding time, connection/disconnection of Bluetooth, and battery. The ‘Music Icon’ area 13 displays an icon representing that a current screen is a music play screen.

The picture display area 14 displays a picture regarding a current song which is being played. The ‘Title’ area 15 displays a title of a current song which is being played. The ‘Progress Bar’ area 16 displays a progress bar, play time information, a play mode, and DNSe of a current song which is being played. The ‘Album/Artist’ 17 displays an album title and an artist name of a current song which is being played. The album title and the artist name are included in metadata of a music file which is being currently played.

The ‘Search’ button 18 permits input of a command to search for a music file. The ‘DNSe’ button 19 is to input a command to change a DNSe sound effect. The ‘Menu’ button 20 permits input of a command to display a menu. The section repeat button 21 permits input of a command to execute a section repeat function.

The contents list display area 110 preferably displays a list of songs which have the same reference attribute value as that of a current song which is being played. That is, the contents list display area 110 displays a list of contents which are related to a current song which is being played. The contents list display area 110 is displayed along with the music play screen. More specifically, the contents list display area 110 is preferably included in the picture display area 14 of the music play screen, and a contents list 116 overlaps a picture. Therefore, a user can search for any other songs related to a current song which is being played while listening to the current song.

The reference attribute value is a value of a reference attribute of a current song which is being played. The reference attribute is a criterion on which contents are filtered. More specifically, the reference attribute may comprise metadata items of a content file or a pre-set playlist. For example, the reference attribute may comprise, for example, an album, an artist, a genre, a rank, a year, and a playlist. The reference attribute value may be an album title, an artist name, a genre name, rank information, a year value, and a playlist name of a current song which is being played.

For example, it is assumed that a title of a current song which is being played is ‘song 1’, an album title is ‘album 1’, and an artist name is ‘artist 1’, and ‘song 1’ is included in ‘playlist 1’ which is created by a user. If the reference attribute is an album, the reference attribute value is ‘album 1’. If the reference attribute is an artist, the reference attribute value is ‘artist 1’. If the reference attribute is a playlist, then the reference attribute value is ‘playlist 1’.

If the content is a picture, the reference attribute may be a color, a size, an F number, a focal distance (f), a year, a camera model, and GPS information.

As shown in the example of FIG. 1, the contents list display area 110 displays a reference attribute value (e.g. type of playlist) 112, a song sequence number 114 including a current song number and the total number of songs, and a contents list 116.

The reference attribute value 112 is an attribute value of a reference attribute of a current song which is being played.

The song sequence number 114 indicates the number of a current song for the total number of songs included in the contents list 116. For example, if the song sequence number 114 is ‘20/500’, there are 500 songs in the contents list 116 in total and the 20^{th} song of them is being currently played.

The contents list 116 comprises a list of songs which have the same attribute value as that of a current song which is being played among the songs stored in the multimedia apparatus. For example, if an album title of a current song is ‘album 1’ and the reference attribute is an album, the contents list 116 is a list of songs which belongs to ‘album 1’, as indicated by album information of metadata, among the songs stored in the multimedia apparatus. Also, if a current song which is being played is included in ‘playlist 1’ created by a user, and if the reference attribute is a playlist, the contents list 116 is a list of songs which are included in ‘playlist 1’ among the songs stored in the multimedia apparatus.

The reference attribute display area 120 (identified in FIG. 1 with “Type of Playlist” displays a reference attribute which is currently set. For example, if the reference attribute is set to an album, the reference attribute display area 120 displays ‘Album’, whereas if the reference attribute is set to an artist, the reference attribute display area 120 displays ‘Artist’, and if the reference attribute is set to a playlist, the reference attribute display area 120 displays ‘Playlist’. If the reference attribute is set to all music, the reference attribute display area 120 displays ‘All Music’.

The change list icon 130 permits input of a command to change a set reference attribute and display the contents list 116 which is filtered according to the changed reference attribute. That is, the change list icon 130 is to input a command to change a reference attribute.

The change list icon 130 may provide a function of changing a reference attribute in a toggled manner. For example, if the change list icon 130 is manipulated in a situation where the reference attribute is set to all music, the reference attribute is changed from ‘All Music’ to ‘Album’. If the change list icon 130 is manipulated in a situation where the reference attribute is set to an album, the reference attribute is changed from ‘Album’ to ‘Artist’. If the change list icon 130 is manipulated in a situation where the reference attribute is set to an artist, the reference attribute is changed from ‘Artist’ to ‘Playlist’. However, if the change list icon 130 is manipulated in a situation where the reference attribute is set to a playlist, the reference attribute is changed from ‘Playlist’ to ‘All Music’.

As described above, using the multimedia apparatus providing the music play screen having the above-described screen configuration, the user can easily access a list of songs related to a current song which is being played while listening to the song.

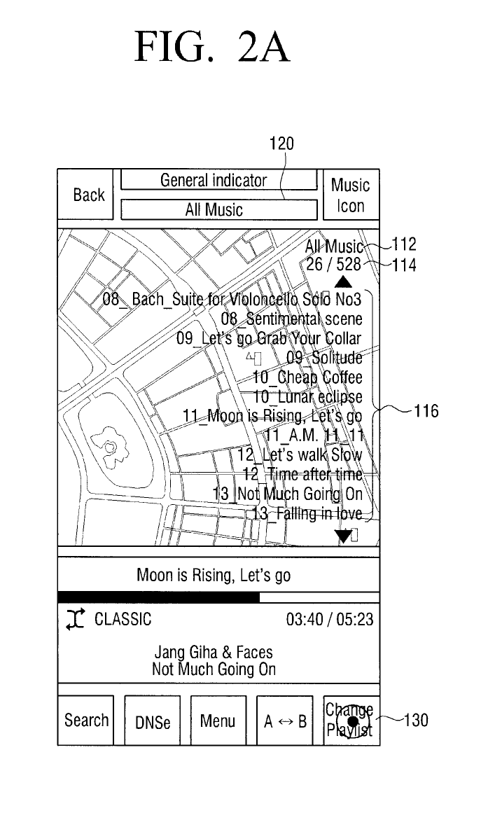

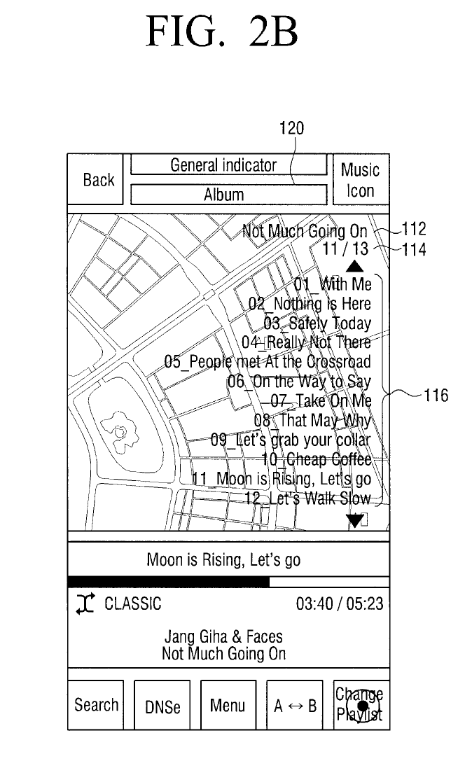

Hereinafter, an example of a music play screen of a multimedia apparatus according to an exemplary embodiment of the present invention will now be explained with reference to FIGS. 2A and 2B. For example, FIG. 2A is a view illustrating a music play screen which displays a list of contents regarding ‘All Music’ while a song is being played according to an exemplary embodiment of the present invention. FIG. 2B is a view illustrating a music play screen which displays a list of contents if a reference attribute is ‘Album’ and a reference attribute value is ‘Not Much Going on’ according to an exemplary embodiment of the present invention.

As shown in FIG. 2A, the reference attribute display area 120 displays ‘All Music’. That is, since the reference attribute is set to ‘All Music’, the contents list 116 contains all songs. Since the reference attribute value 112 is ‘All Music’ and the song sequence number 114 is ‘26/528’, there are 528 songs in total and the 26^{th} song is being currently played.

If the user touches the change list icon 130 in this situation, the screen is changed to a screen of FIG. 2B. As shown in FIG. 2B, the reference attribute display area 120 displays ‘Album’. Also, the reference attribute value 112 is an album entitled ‘Not Much Going on’. That is, the album title is ‘Not Much Going On’ of which a current song is being played. The contents list 116 is a list of songs which are included in the album titled ‘Not Much Going On’. Referring to the song sequence number 114, the album titled ‘Not Much Going On’ includes 13 songs in total and the 11^{th} song of them entitled “Moon is Rising, Let's go’ is currently being played.

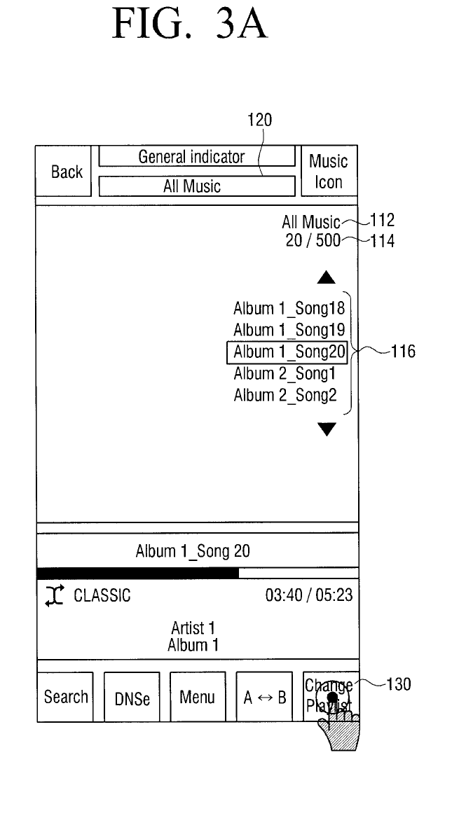

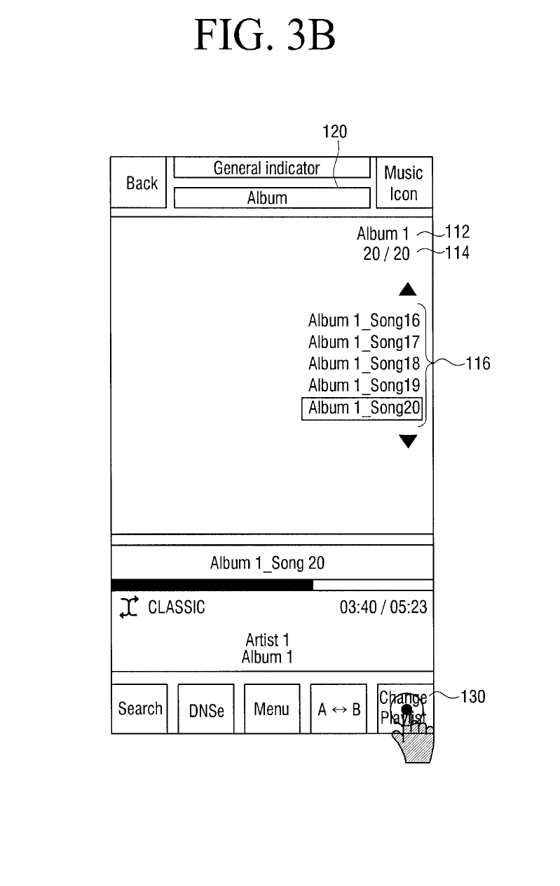

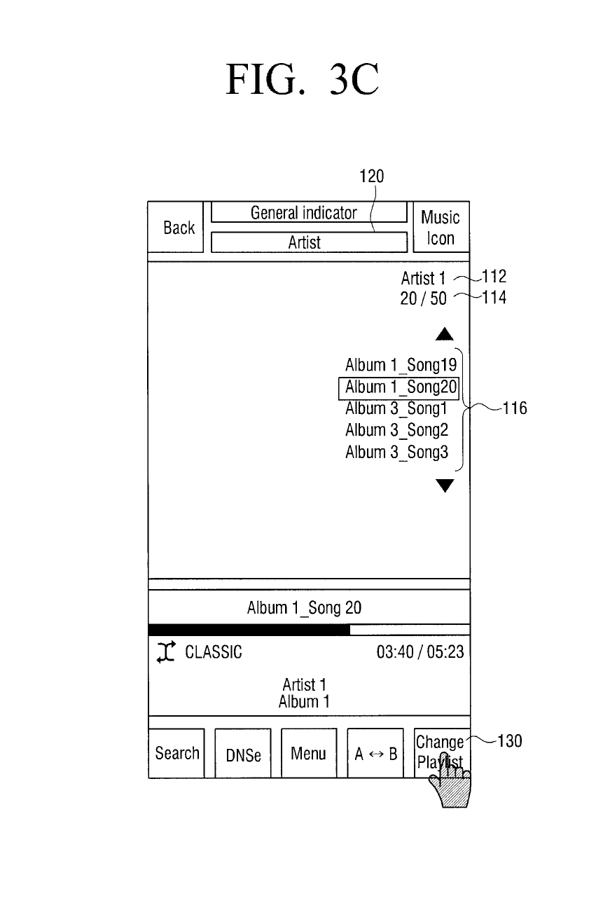

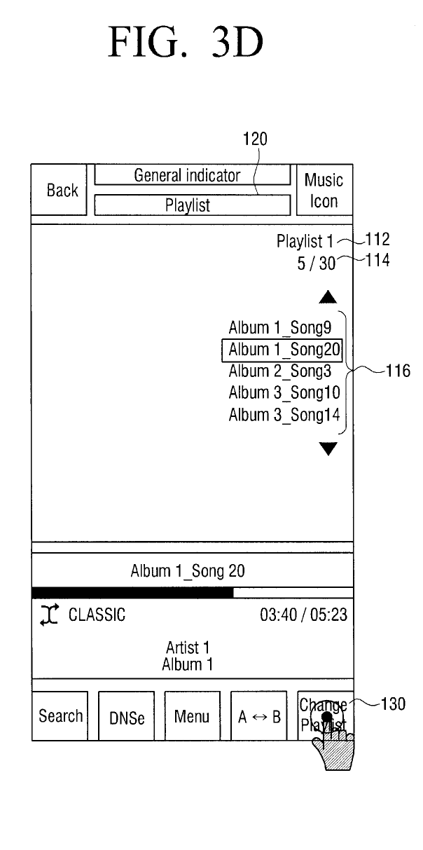

Hereinafter, a method of manipulating the above-described music play screen will be explained with reference to FIGS. 3A to 3D. In FIGS. 3A to 3D, a song title is illustrated as ‘album title_song title’ for convenience of explanation. For example, if a song title is ‘Album 1_Song 20’, the album title of the song is ‘Album 1’ and the song title is ‘Song 20’.

FIG. 3A is a view illustrating a music play screen which displays a contents list 116 regarding ‘All Music’ while a song is being played according to an exemplary embodiment of the present invention. As shown in FIG. 3A, a current song which is being played is titled ‘Album 1_Song 20’.

As shown in FIG. 3A, since the reference attribute display area 120 displays ‘All Music’, the reference attribute is set to ‘All Music’. Accordingly, the reference attribute value 112 is also set to ‘All Music’. Also, since the song sequence number 114 is ‘20/500’, there are 500 songs in total and the current song ‘Album 1_Song 20’ which is being played is the 20^{th} song out of 500. That is, the current contents list 116 is a list containing all songs which are stored in the multimedia apparatus.

If the user touches the change list icon 130 in this situation, a screen shown in FIG. 3B is displayed.

FIG. 3B is a view illustrating an example of a music play screen which displays a list of contents if the reference attribute is ‘Album’ and the reference attribute value is ‘Album 1’ according to an exemplary embodiment of the present invention.

As shown in FIG. 3B, the reference attribute is set to ‘Album’ since the reference attribute display area 120 displays ‘Album’. The reference attribute value 112 is set to ‘Album 1’. That is, the current song ‘Album 1_Song 20’ which is being played is included in an album titled ‘Album 1’.

Also, since the song sequence number 114 is ‘20/20’, there are 20 songs in the album titled ‘Album 1’ in total and the current song ‘Album 1_Song 20’ is the 20^{th} song.

The current contents list 116 is a list of songs which are included in the same album as that of the current song which is being played among the songs stored in the multimedia apparatus. That is, the current contents list 116 is a list of songs which are included in the album ‘Album 1’.

If the user touches the change list icon 130 in this situation, a screen shown in FIG. 3C is then displayed.

FIG. 3C is a view illustrating an example of a music play screen which displays a list of contents if the reference attribute is ‘Artist’ and the reference attribute value is ‘Artist 1’ according to an exemplary embodiment of the present invention.

As shown in FIG. 3C, the reference attribute is set to ‘Artist’ since the reference attribute display area 120 displays ‘Artist’. Also, the reference attribute value 112 is set to ‘Artist 1’. That is, the artist name of the current song ‘Album 1_Song 20’ is ‘Artist 1’.

Also, since the song sequence number 114 is ‘20/50’, there are 50 songs under the particular artist ‘Artist 1’ and the current song ‘Album 1_Song 20’ is the 20^{th} song of them.

The current contents list 116 is a list of songs which have the same artist name as that of the current song among the songs stored in the multimedia apparatus. That is, the current contents list 116 is a list of songs which are owned (or performed) by artist ‘Artist 1’.

If the user touches the change list icon 130 in this situation, a screen shown in FIG. 3D is displayed.

FIG. 3D is a view illustrating an example of a music play screen which displays a list of contents if the reference attribute is ‘Playlist’ and the reference attribute value is ‘Playlist 1’ according to an exemplary embodiment of the present invention.

As shown in FIG. 3D, the reference attribute is set to ‘Playlist’ since the reference attribute display area 120 displays ‘Playlist’. The reference attribute value 112 is set to ‘Playlist 1’. That is, the current song ‘Album 1_Song 20’ which is being played belongs to a playlist titled ‘Playlist 1’. The playlist is a list which is arbitrarily created by a user and may contains songs from many different artists and styles.

Also, since the song sequence number 114 is ‘5/30’, there are 30 songs belonging to ‘Playlist 1’ in total and the current song ‘Album 1_Song 20’ is the 5^{th} song of them.

The current contents list 116 is a list of songs which belong to the same playlist as that of the current song among the songs stored in the multimedia apparatus. That is, the current contents list 116 is a list of songs which belong to ‘Playlist 1’ among the songs stored in the multimedia apparatus.

If the user touches the change list icon 130 in this situation, then the screen shown in FIG. 3A is displayed again.

If a touch manipulation is input on the change list icon 130, the multimedia apparatus changes the reference attribute in the order of ‘All Music’, ‘Album’, ‘Artist’, and ‘Playlist’, and displays the contents list 116 according to each reference attribute.

As described above, according to this aspect of the present invention, the user can check a list of songs related to a current song which is being played according to each attribute of music simply by touching the change list icon 130 on the music play screen. Therefore, the user can check a list of contents by a simple manipulation.

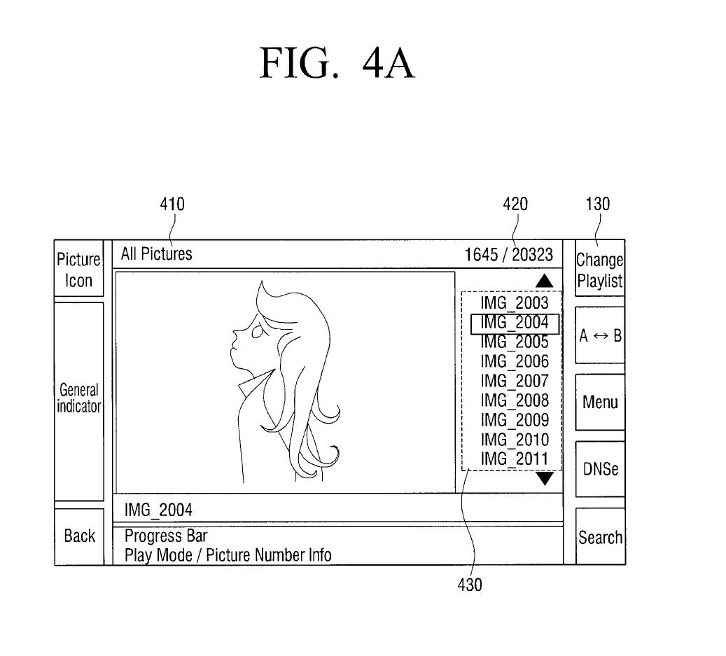

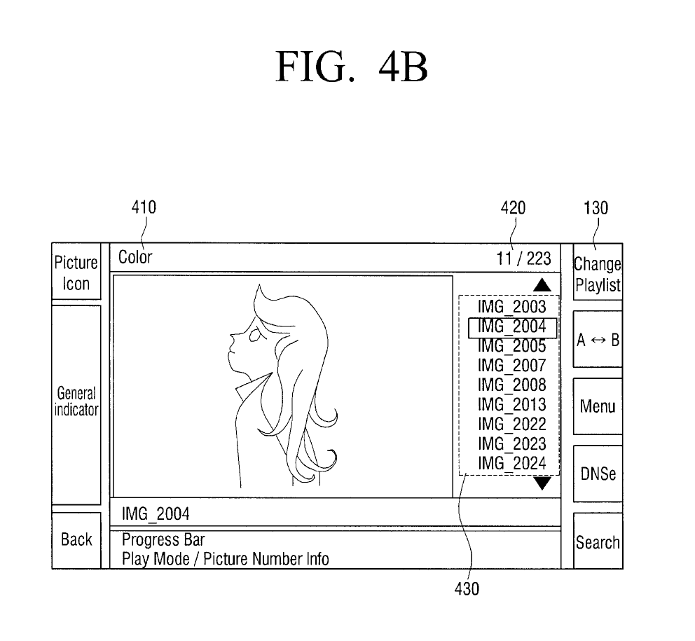

Up to now, a guide user interface (GUI) to display a list of songs related to a current song which is being played was described with reference to FIGS. 1 to 3D. In the above exemplary embodiments, the content is music. However, the present invention can be applied to any other type of multimedia contents. For example, the content may be a picture, a video, or a document. Hereinafter, a GUI to be displayed if content is a picture will now be explained with reference to FIGS. 4A and 4B.

FIG. 4A is a view illustrating a picture display GUI which displays a list of contents by file name regarding all pictures while a picture is being displayed according to an exemplary embodiment of the present invention. As shown in FIG. 4A, a picture named ‘IMG_{—}2004’ is currently being displayed.

In FIG. 4A, a reference attribute is set to all pictures since a reference attribute display area 410 displays ‘All Pictures’. Also, since a picture sequence number 420 is ‘1645/20323’, there are 20323 pictures in total and the currently displayed picture ‘IMG_{—}2004 ’ is the 1645^{th} picture of them. That is, a current contents list 430 is a list of all pictures stored in the multimedia apparatus.

If a user touches a change list icon 130 in this situation, a screen shown in FIG. 4B is then displayed.

FIG. 4B is a view illustrating a picture display screen which displays a contents list 430 if the reference attribute is set to ‘Color’ according to an exemplary embodiment of the present invention.

In FIG. 4B, the reference attribute is set to a color since the reference attribute display area 410 displays ‘Color’. It is assumed that the currently displayed picture ‘IMG_{—}2004’ has a color attribute value of ‘Color 1’.

Since the picture sequence number 420 is ‘11/223’, there are 223 pictures having a color attribute value of ‘ Color 1’ and the currently displayed picture ‘IMG_{—}2004’ is the 11^{th} picture.

The current contents list 430 comprises a list of pictures which have the same color attribute value as that of the currently displayed picture among the pictures stored in the multimedia apparatus. That is, the current contents list 430 is a list of pictures which have a color attribute value of ‘Color 1’ among the pictures stored in the multimedia apparatus.

If the user touches the change list icon 130 in this situation, a contents list according to a different reference attribute is displayed.

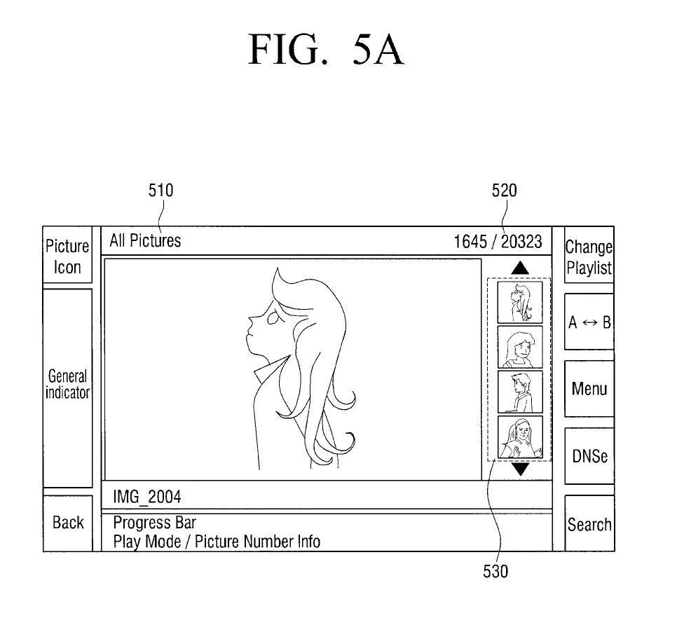

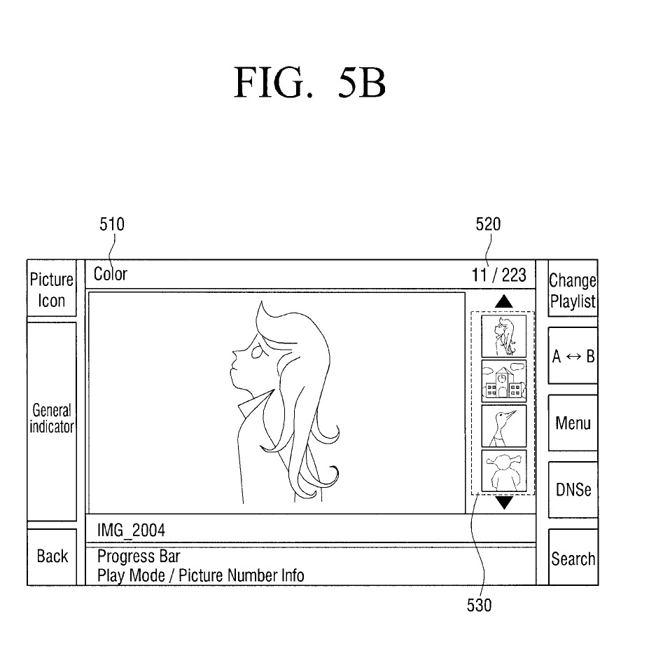

In the above exemplary embodiment, the contents list 430 is displayed with the title of the content. However, the contents list 430 may be displayed in the form of a thumbnail. This will be described with reference to FIGS. 5A and 5B.

FIG. 5A is a view illustrating a picture display screen which displays a contents list 530 regarding all pictures in the form of respective thumbnails that are scrollable according to an exemplary embodiment of the present invention. FIG. 5B is a view illustrating a picture display screen which displays a contents list 530 in the form of respective thumbnails if the reference attribute is ‘Color’ according to an exemplary embodiment of the present invention.

As shown in FIGS. 5A and 5B, the picture display screen includes a reference attribute display area 510, and a picture sequence number 520 and a contents list 530 in the form of a thumbnail are displayed. Since FIGS. 5A and 5B are similar to FIGS. 4A and 4B, a detailed description of FIGS. 5A and 5B is omitted.

Unlike FIGS. 4A and 4B, FIGS. 5A and 5B illustrate the contents list 530 in the form of thumbnails. If the contents list 530 is displayed in the form of thumbnails, the user can check the content he/she desires in advance and thus easily select it, as opposed to a file name which may have no relevance that a user can discern to search for a particular image.

Up to now, a method for providing a list of contents regarding current content which is being played by a multimedia apparatus and a GUI manipulating method thereof were described with reference to FIGS. 1 to 5B.

Hereinafter, exemplary operation of a method for providing a list of contents by a multimedia apparatus will be described with reference to FIG. 6.

FIG. 6 is a flowchart illustrating a method for displaying a list of contents according to an exemplary embodiment of the present invention.

At step (S610), a multimedia apparatus plays specific content on a content play screen. For example, the multimedia apparatus plays specific music or video if the content is music or video. Also, the multimedia apparatus may display a specific picture or document if the content is a picture or document.

At step (S620), the multimedia apparatus sets any one of attributes of current content which is being played, as a reference attribute. The reference attribute refers to a criterion on which contents are filtered. A reference attribute value refers to an attribute value of the reference attribute of the current content.

More specifically, the reference attribute may comprise metadata items of a content file or a pre-set playlist. For example, the reference attribute of music content may be an album, an artist, a genre, a rank, a year, or a playlist. The reference attribute value of music content may be an album title, an artist name, a genre name, rank information, a year value, a playlist name of a current song which is being played.

For example, it is assumed that a title of a current song which is being played is ‘song 1’, an album title is ‘album 1’, and an artist name is ‘artist 1’, and ‘song 1’ belongs to ‘playlist 1’ created by a user. If the reference attribute is an album, the reference attribute value is ‘album 1’. If the reference attribute is an artist, the reference attribute value is ‘artist 1’. If the reference attribute is a playlist, the reference attribute value is ‘playlist 1’.

If content is a picture, the reference attribute may be, for example, a color, a size, an F number, a focal distance (f), a year, a camera model, or GPS information.

Next, at step (S630) the multimedia apparatus displays a list of contents which have the same attribute value as that of the current content which is being played on the content play screen. The multimedia apparatus displays the list of contents along with the current content which is being played. The screen which displays the list of contents is illustrated in FIGS. 1 through 5B.

Next, at step (S640) the multimedia apparatus determines whether a command to change the reference attribute is input or not. If the command to change the reference attribute is not input (S640-N) and if playing contents is terminated (5660-Y), the multimedia apparatus finishes playing content.

Herein, the command to change the reference attribute may be input by manipulating a specific icon. For example, the change list icon 130 illustrated in FIGS. 1 to 5B is an icon to input a command to change the reference attribute. Therefore, if a specific icon is manipulated, a command to change the reference attribute is input.

If the command to change the reference attribute is input (S640-Y), then at step (S650) multimedia apparatus changes the current reference attribute. The number of reference attributes and an order of changing the reference attribute are pre-set. Therefore, the multimedia apparatus changes the current reference attribute in sequence according to the number of reference attributes and the order of changing the reference attribute. For example, the multimedia apparatus may change the reference attribute in sequence in the order of ‘All Music’, ‘Album’, ‘Artist’, and ‘Playlist’ as shown in FIGS. 3A to 3D. In this case, the number of reference attributes is 4 and the order of changing the reference attribute is ‘All Music’, ‘Album’, ‘Artist’, and ‘Playlist’.

Next, the multimedia apparatus repeats the operation (S630) of displaying the list of contents which correspond to the current content which is being played in terms of the attribute value of the changed reference attribute.

As described above, the multimedia apparatus displays a list of contents related to current content that is being played on a content play screen, so that the user can easily use the list of contents related to the current content while playing the content.

Also, the user can check a list of contents related to current content which is being played according to each attribute of the content by touching a specific icon. Therefore, the user can check a list of contents he/she desires through a simple manipulation.

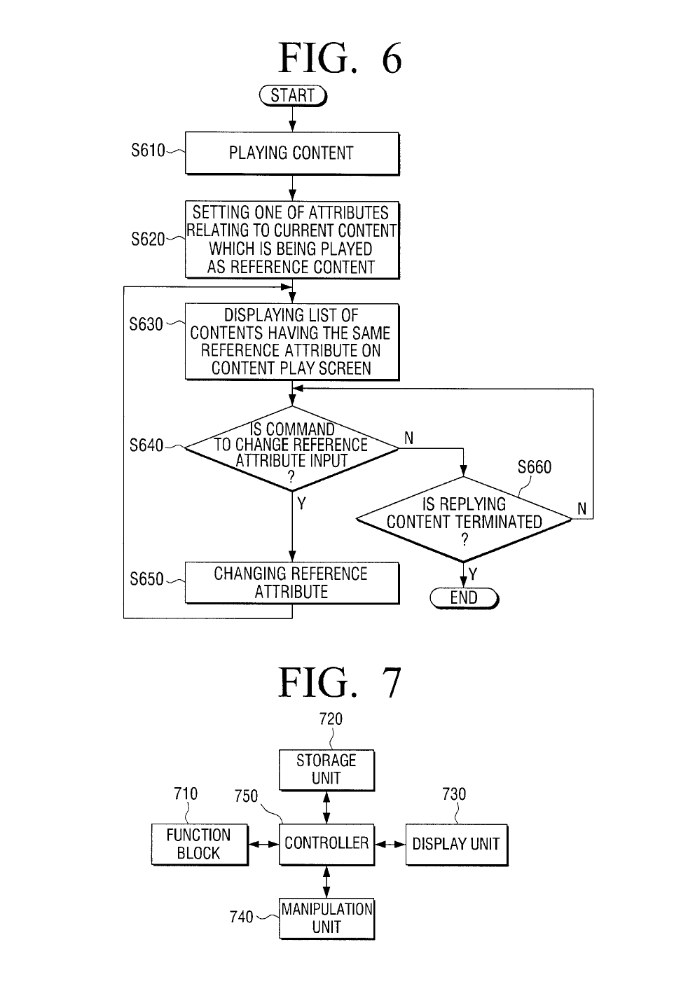

Hereinafter, a multimedia apparatus to which the present invention is applicable will be described with reference to FIG. 7. FIG. 7 is a block diagram illustrating a multimedia apparatus to which the present invention is applicable. As shown in FIG. 7, the multimedia apparatus includes a function block 710, a storage unit 720, a display unit 730, a manipulation unit 740, and a controller 750.

The function block 710 performs the peculiar function of the multimedia apparatus. If the multimedia apparatus is a MP3 player, the function block 710 performs the function of the MP3 player, and if the multimedia apparatus is a PMP, the function block 710 performs the function of the PMP.

The storage unit 720 is an internal storage medium in which a plurality of contents is stored. Also, the storage unit 720 stores metadata of contents and a list which is pre-set by a user. For example, the storage unit 720 may a hard disk or a memory.

The display unit 730 displays an input image and displays a GUI to play contents. More specifically, the display unit 730 displays a GUI to play contents as shown in FIGS. 1 to 5B.

The manipulation unit 740 receives a manipulation to input a specific command from a user. For example, the manipulation unit 740 may include a button, a wheel, and a touch screen. In particular, the manipulation unit 740 may include a touch screen to touch an icon displayed on a screen.

The controller 750 performs the operations described in the flowchart of FIG. 6 such that the multimedia apparatus displays the list of contents on the content play screen.

More specifically, the controller 750 plays specific content and displays a current status of the content being played on the content play screen. For example, if content is music or video, the multimedia apparatus plays specific music or video. If content is a picture or a document, the multimedia apparatus displays the picture or the document on a screen.

The controller 750 sets at least one of the attributes of current content which is being played as a reference attribute, and displays a list of contents which correspond to the current content in terms of an attribute value of the reference attribute on the content play screen.

More specifically, the controller 750 controls displaying the list of contents which have the same attribute value as that of the current content which is being played on the content play screen. Also, the controller 750 controls displaying the list of content along with the current content on the content play screen. Herein, the reference attribute is a criterion on which contents are filtered. The reference attribute value is an attribute value of the reference attribute of the current content which is being played.

More specifically, the reference attribute may be metadata items of a content file or a pre-set playlist. For example, the reference attribute of music content may be an album, an artist, a genre, a rank, a year, and a playlist. The reference attribute value of music content may be an album title, an artist name, a genre name, rank information, a year value and a playlist name of a current song which is being played

For example, it is assumed that a title of a current song which is being played is ‘song 1’, an album title is ‘album 1’, and an artist name is ‘artist 1’, and ‘song 1’ is included in ‘playlist 1’ which is created by a user. If the reference attribute is an album, the reference attribute value is ‘album 1’. If the reference attribute is an artist, the reference attribute value is ‘artist 1’. If the reference attribute is a playlist, the reference attribute value is ‘playlist 1’.

If the content is a picture, the reference attribute may be, for example, a color, a size, an F number, a focal distance (f), a year, a camera model, and GPS information.

If the reference attribute is changed by a user manipulation, the controller 750 controls displaying a list of contents which correspond to the current content which is being played in terms of a reference attribute value of the changed reference attribute on the content play screen.

The controller 750 may control an icon, which receives a command to change the reference attribute, to be displayed, and if the icon is manipulated by the user, the controller 750 controls displaying a list of contents which correspond to the current content which is being played in terms of a reference attribute value of the changed reference attribute on the content play screen.

The controller 750 pre-sets the number of reference attributes and an order of changing the reference attribute. Therefore, if a command to change the reference attribute is input, the controller 750 changes the current reference attribute in sequence according the number of reference attributes and the order of changing the reference attribute. For example, as shown in FIGS. 3A to 3D, the multimedia apparatus changes the reference attribute in the order of ‘All Music’, ‘Album’, ‘Artist’, and ‘Playlist’. In this case, the number of reference attributes is 4 and the order of changing the reference attribute is ‘All Music’, ‘Album’, ‘Artist’, and ‘Playlist’.

Also, the controller 750 may control the multimedia apparatus to provide the content play screen shown in FIGS. 1 to 5B and perform a manipulating method thereof.

The present invention can be applied any type of multimedia apparatus that can play multimedia contents. For example, the multimedia apparatus may be a MP3 player, a PMP, a mobile phone, a personal digital assistant (PDA), a TV, or a laptop computer.

According to various exemplary embodiments of the present invention, at least one attribute of current content which is being played is set as a reference attribute, and a list of contents which correspond to the current content in terms of an attribute value of the reference attribute is displayed on a content play screen, so that a user can easily use a list of contents as he/she desires. While the examples disclosed and described herein were directed to one attribute being the reference attribute, the claimed invention also applies to more than one attribute being set as a reference attribute. For example, musical artists wearing a particular color of clothing could a complex attribute to fine tune some particular cross section that a user desires. Also, it is possible and within the scope of the claimed invention that one could be setting the attribute values remotely, such as using a portable terminal and setting attribute for a multimedia device installed in an automobile, or displaying the contents on a television screen for a multimedia apparatus that are part of a home network such as a DLNA network. In addition, the multimedia apparatus might not be accessing specific content while the reference attribute is being set.

The above-described methods according to the present invention can be realized in hardware or as software or computer code that can be stored in a recording medium such as a CD ROM, a RAM, a floppy disk, a hard disk, thumbnail drive, detachable memory such as an SD memory card or memory stick, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method for providing a list of contents, the method comprising:
setting at least one attribute relating to a specific content of a multimedia device as a reference attribute; and
displaying on a content play screen a list of contents which correspond to the specific content in terms of an attribute value of the reference attribute.

2. The method as claimed in claim 1, wherein the setting step is performed as specific content is being played by the multimedia device, and the list of contents is displayed by the multimedia device.

3. The method as claimed in claim 1, wherein the displaying operation displays a list of contents which have the same attribute value as that of the specific content on the content play screen.

4. The method as claimed in claim 1, wherein the list of contents displayed on the content play screen is scrollable when the content play screen cannot display an entire list of contents in a single view.

5. The method as claimed in claim 1, wherein the reference attribute comprises at least one of metadata items of the specific content and a pre-set list.

6. The method as claimed in claim 5, wherein the specific content comprises music content, and the reference attribute is at least one of an album, an artist, a genre, a rank, a year, and a playlist.

7. The method as claimed in claim 5, wherein the specific content comprises multimedia content.

8. The method as claimed in claim 5, wherein the specific content comprises picture content, and the reference attribute is at least one of a color, a size, an F-number, a focal distance (f), a year, a camera model, and GPS information associated with the picture content.

9. The method as claimed in claim 1, wherein, if the reference attribute is changed, the displaying operation displays on the content play screen a list of contents which correspond to the specific content in terms of an attribute value of the changed reference attribute.

10. The method as claimed in claim 9, further comprising displaying an icon to receive a command to change the reference attribute, and
wherein, in response to detecting that the icon has been manipulated, displaying on the content play screen a list of contents which correspond to the specific content in terms of an attribute value of the changed reference attribute.

11. The method as claimed in claim 10, wherein there are a pre-set number of reference attributes and the reference attribute is changed in a pre-set order, and
wherein the method further comprises changing the reference attribute in sequence according to the pre-set number and the pre-set order upon detecting manipulation of the icon.

12. A multimedia apparatus comprising:
a display unit which displays a video and a guide user interface (GUI); and
a controller which controls playing specific content, setting at least one of attribute relating to the specific content as a reference attribute, and displaying a list of contents which correspond to the specific content in terms of an attribute value of the reference attribute on a content play screen.

13. The multimedia apparatus as claimed in claim 12, wherein the controller controls displaying a list of contents which have the same attribute value as that of the specific content on the content play screen.

14. The multimedia apparatus as claimed in claim 13, wherein the specific content is being played by the apparatus while the reference attribute is set.

15. The multimedia apparatus as claimed in claim 12, wherein the controller controls displaying the list of contents on the content play screen while the specific content is being played.

16. The multimedia apparatus as claimed in claim 12, wherein the reference attribute comprises at least one a metadata item of the specific content and a pre-set list.

17. The multimedia apparatus as claimed in claim 16, wherein the specific content comprises music content, and the reference attribute comprises at least one of an album, an artist, a genre, a rank, a year, and a playlist.

18. The multimedia apparatus as claimed in claim 16, wherein the specific content comprises picture content, and the reference attribute comprises at least one of a color, a size, an F-number, a focal distance (f), a year, a camera model, and GPS information.

19. The multimedia apparatus as claimed in claim 12, wherein, if the reference attribute is changed, the controller controls displaying on the content play screen a list of contents which correspond to the specific content in terms of an attribute value of the changed reference attribute.

20. The multimedia apparatus as claimed in claim 19, wherein the controller controls displaying an icon to receive a command to change the reference attribute, and, upon detecting manipulation of the icon, the controller controls displaying a list of contents on the content play screen which correspond to the specific content in terms of an attribute value of the changed reference attribute.

21. The multimedia apparatus as claimed in claim 20, wherein when there are a pre-set number of reference attributes and the reference attribute is changed in a pre-set order, the controller changes the reference attribute in sequence according to the pre-set number and the pre-set order upon detection of manipulation of the icon.
